(19) United States
(12) Patent Application Publication
(10) Pub. No.: US 2026/0044582 A1
(43) Pub. Date: Feb. 12, 2026

(54) METHODS AND SYSTEMS FOR WATERMARKING CONTENT

(71) Applicant: Comcast Cable Communications, LLC, Philadelphia, PA (US)

(72) Inventors: Joseph Phillip FOREHAND, PARKER, CO (US); Gregory Scott FORGET, LONE TREE, CO (US); Marc Anthony GATTO, SUMMERVILLE, SC (US)

(21) Appl. No.: 18/798,398

(22) Filed: Aug. 8, 2024

(51) Int. Cl. G06F 21/16

(52) U.S. Cl. CPC G06F 21/16

(57) ABSTRACT

Methods and systems are described for providing content. A user may request content. The content may be analyzed to determine a plurality of locations in the content. A subset of the plurality of locations may be determined. The subset may be associated with a particular user account associated with the request. Watermarked data may be added to the subset of locations. The content comprising the watermarked data may be sent to the user in response to the request. The content may be analyzed to determine, based on the specific subset of locations, which user account is authorized to access the content.

### BACKGROUND

Content distribution has improved with the digitization of the modern content. This has allowed content distribution platforms to provide content for streaming via subscription services to a large variety of devices. However, the digitization of content may allow people to steal or share the content with unauthorized users. Thus, there is a need for more sophisticated techniques for determining when a person may have stolen or are sharing content.

### SUMMARY

Methods and systems for providing watermarked content are disclosed. A computing device may receive a request for content (e.g., a show, movie, live stream, or other media) from a user device. The computing device may retrieve the content and determine a set of frames for adding watermark data. The set of frames may be selected to uniquely identify the user device (e.g., or user account associated with the user device). The set of frames may be selected at random, but may be checked to ensure that the set of frames is not already associated with another user device. The content may be watermarked (e.g., or a watermarked copy may be generated) by adding the watermarking data to the determined set of frames. The watermarked content may be sent to the user device requesting the content. An association of the user device (e.g., or user account) and the specific set of frames of the content may be stored. The association may be used to analyze a portion of the content, such as prior to playback, as part of request for the content, or as part of process for detection of unauthorized access to content.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2A shows an example system.

FIG. 2B shows an example watermarking process.

FIG. 2C shows an example watermarking process.

FIG. 3 shows an example method.

FIG. 4 shows an example method.

FIG. 5 shows an example method.

FIG. 6 is a block diagram illustrating an example computing device.

### DETAILED DESCRIPTION OF ILLUSTRATIVE EMBODIMENTS

Content streaming has become prevalent in the way users may view content. In some examples, content providers may grant access to content via subscriptions or the like. Users are able to purchase access to content. However, some users may abuse access to the content and share with unauthorized people. In another example, content may also be stolen from content providers networks or services by users who abuse access. This may be a costly problem to content providers. The present disclosure relates to systems and methods for watermarking content. The content may comprise a plurality of frames. In some examples, a subset of frames may be randomly selected from the plurality of frames of content. Watermark data may be applied (e.g., added) to the subset of frames. The subset of frames selected may not be the same for one or more users. A watermarked copy of content may be provided to a user. The watermarked copy may comprise the watermarked subset of frames. The location (e.g., frame location, bit location, stream time location) associated with the watermarked subset of frames may be utilized to identify and/or verify a user’s authorization (e.g., access) to the content.

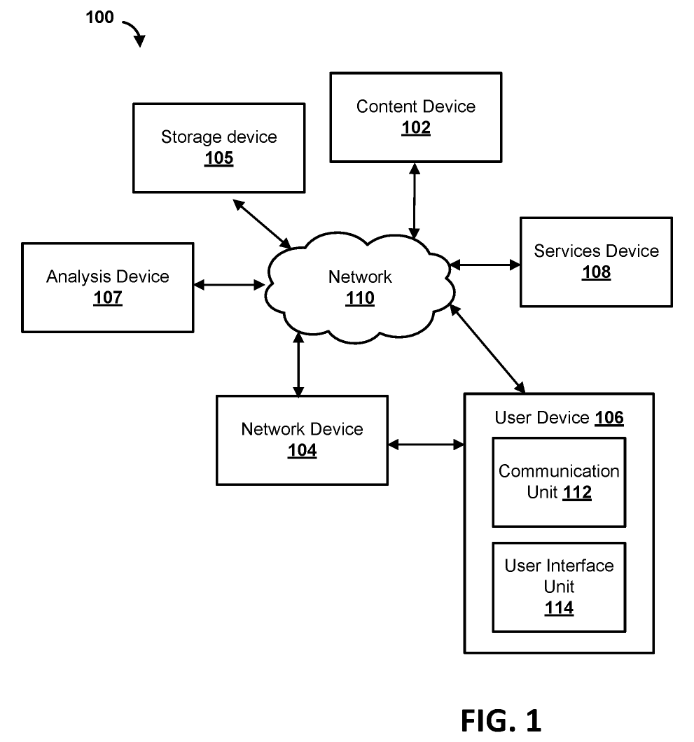

FIG. 1 shows a block diagram of an example system 100. The system 100 may comprise a content device 102 (e.g., content server, edge device), a network device 104 (e.g., gateway device, a termination system, a cable modem termination system, a network node, or combination thereof), a storage device 105, a user device 106, an analysis device 107, a services device 108 (e.g., an application device, application server), or a combination thereof. It should be noted that while the singular term device is used herein, it is contemplated that some devices may be implemented as a single device or a plurality of devices (e.g., via load balancing). The content device 102, the network device 104, the storage device 105, the user device 106, the analysis device 107, and/or the services device 108 may each be implemented as one or more computing devices. Any device disclosed herein may be implemented using one or more computing nodes, such as virtual machines, executed on a single device and/or multiple devices.

The content device 102, the network device 104, the storage device 105, the user device 106, the analysis device 107, and/or the service device 108 may be communicatively coupled via one or more networks, such as network 110 (e.g., a wide area network). The network 110 may comprise a content distribution and/or access network. The network 110 may facilitate communication via one or more communication protocols. The network 110 may comprise fiber, cable, a combination thereof. The network 110 may comprise wired links, wireless links, a combination thereof, and/or the like. The network 110 may comprise routers, switches, nodes, gateways, servers, modems, and/or the like.

The services device 108 may be configured to provide one or more services, such as account services, application services, network services, content services, or a combination thereof. The services device 108 may comprise services for one or more applications on the user device 106. The services device 108 may generate application data associated with the one or more application services. The application data may comprise data for a user interface, data to update a user interface, data for an application session associated with the user device 106, and/or the like.

The services device 108 may be configured to determine to send information (e.g., configuration settings, notifications, information about the premises) to the user device 106, the network device 104, or a combination thereof. The content device 102 may comprise information rules associating various values, patterns, account information, and/or the like with corresponding information. The information may be sent to the user device 106 based on the information rule being triggered and/or satisfied. The information may comprise a configuration setting of the network device 104 and/or the user device 106.

The user device 106 may comprise a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device 106 may be configured to communicate with the content device 102, the network device 104, the storage device 105, the analysis device 107, and/or the like. The user device 106 may be configured to output a user interface. The user interface (e.g., user interface unit 114) may be output via the user interface via an application, service, and/or the like, such as a content browser. The user interface may receive application data from the services device 108. The application data may be processed by the user device 106 to cause display of the user interface.

The user interface may be displayed on a display of the user device 106 (e.g., or controlled by the user device 106). The display may comprise a television, screen, monitor, projector, and/or the like. The user interface may comprise a content management application (e.g., for accessing video, audio, gaming, and/or other media), a smart assistant application, a virtual assistant application, a premises security application, network services application, or a combination thereof. The user interface may be configured to output content via a content browser. The user interface may be configured to provide a plurality of channels (e.g., video channels), streams, video on demand items, audio items, and/or the like. The user interface may be configured to allow a user to configure settings associated with the network device 104.

The network device 104 may comprise a computing device, a gateway device, an access point (e.g., wireless access point), a router, a modem, device controller (e.g., automation controller, security controller, premises health controller, content device controller) a combination thereof, and/or the like. The network device 104 may be configured to communicate using network 110. The network device 104 may be configured to implement one or more services associated with the services device 108, such as a content service, a premises service, a voice controlled service, an automation service, a security service, a health monitoring service, or a combination thereof.

The services device 108 may be configured to determine content comprising a plurality of frames. The content may be determined (e.g., accessed, located) based on a request from a user device 106 associated with a user account. The services device 108 may be configured to determine based on a machine learning model (e.g., or other model, rule, heuristic) whether to watermark the content. The machine learning model may be configured to one or more of: indicate a risk level associated with the content or indicate whether to watermark the content or not. The machine learning model may comprise a binary classifier configured to indicate whether or not to watermark the content. The machine learning model may be configured to provide a probability indicating the risk level. The machine learning model may be trained on a dataset comprising synthesized user traffic, a set of test media assets, real-time data, or the like, or any combination thereof. Real-time data may be captured via a content distribution network (e.g., network 110). Real-time data may include any number of datapoints associated with a user or a plurality of users such as but not limited to a user Internet Protocol (IP) address, geographical location (e.g., derived from IP address), number of play occurrences from IP address (e.g., how many times content may have be accessed), session identification (ID) for playback and adaptive bitrate (ABR) variant consumption, popularity associated with content, or any other suitable datapoint, or any combination thereof.

The machine learning model may comprise a supervised learning model that is trained by synthesizing user traffic against a set of test media assets. The machine learning model may be implemented first as a training model. If training is successfully completed, the machine learning model may be promoted into production to be used to process requests for content from users.

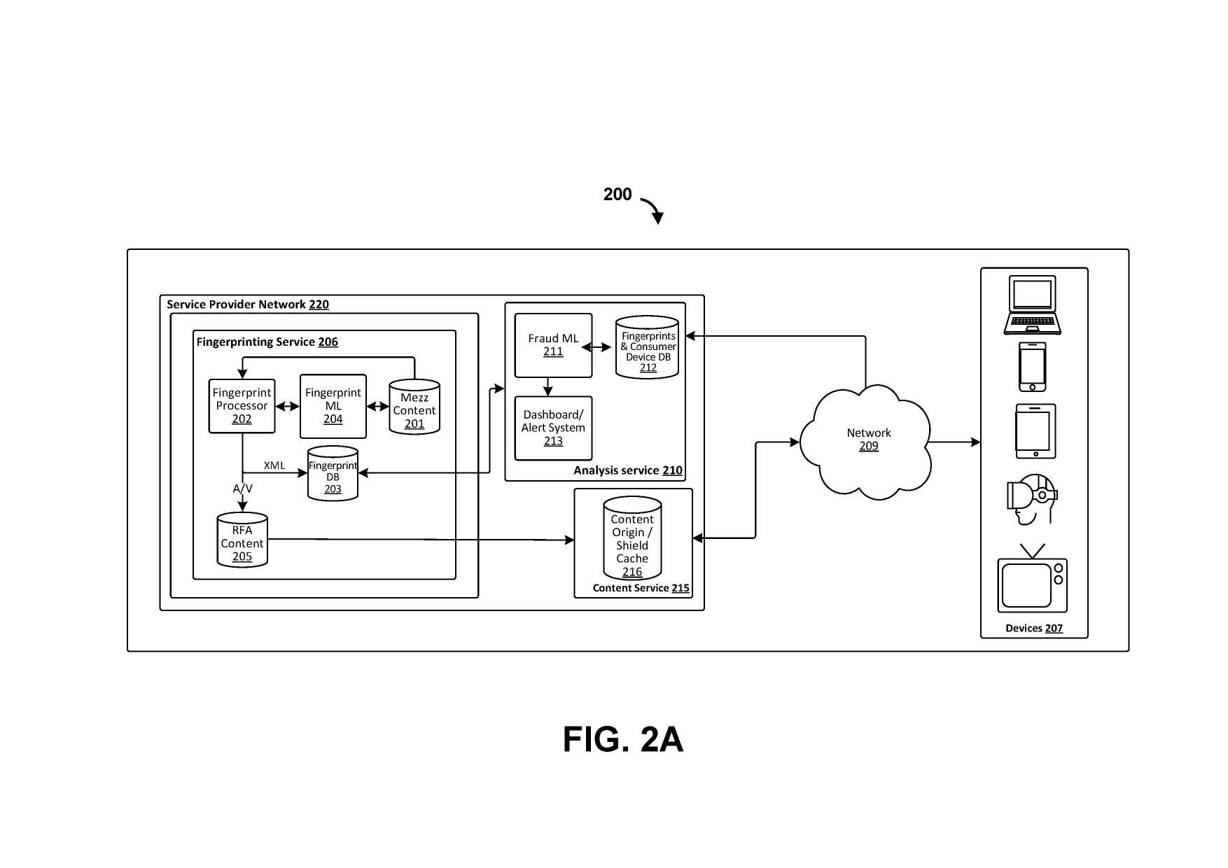

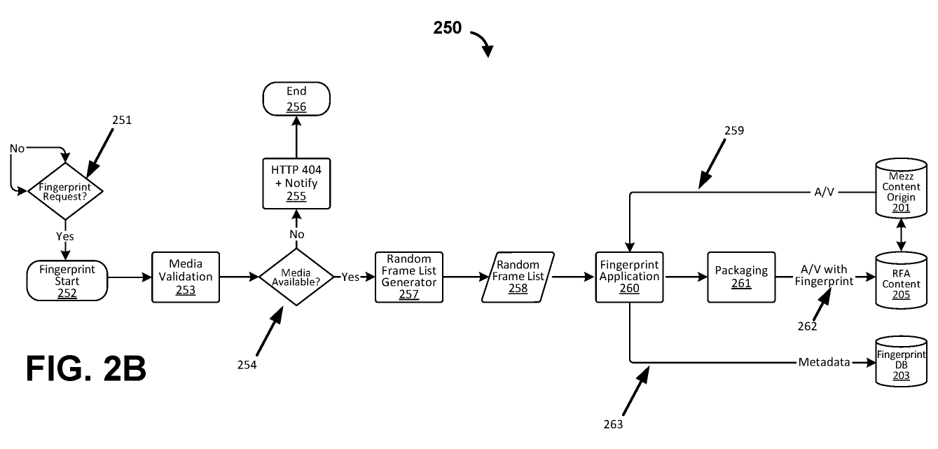

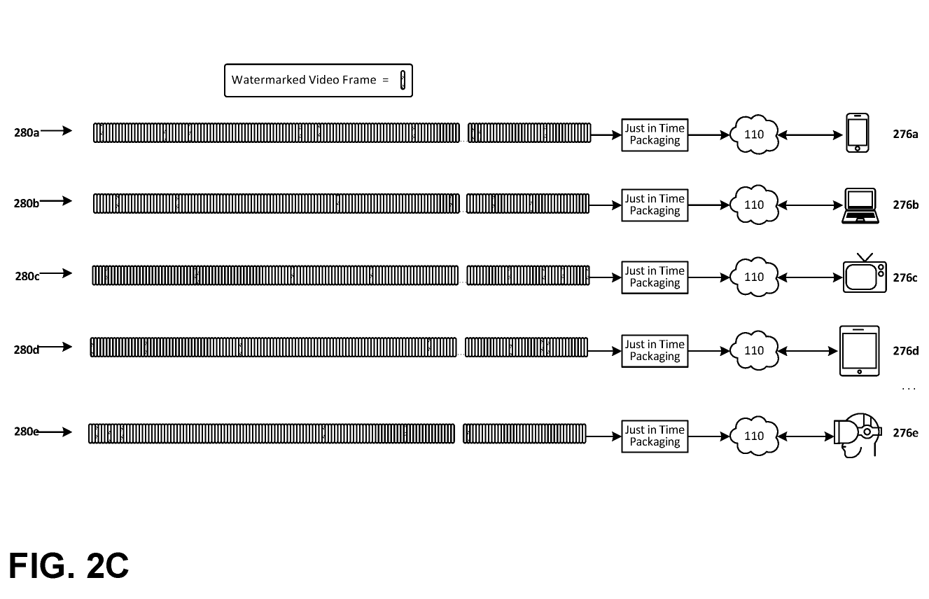

Training data for training the model may comprise content distribution data (e.g., real-time data in JSON format) from a content distribution network (CDN), including but not limited to: unix epoch timestamp, a user internet protocol (IP) address, general location data of IP address (e.g., geo location derived from IP address, down to zipcode where available), an IP address owner (e.g., if from an internet service provider / fixed wireless provider, the company name may be included; if from a VPN service, then the VPN provide name may be included), a number of play occurrences from IP address, a session ID for playback, adaptive bitrate (ABR) variant consumption, a material ID of content requested, a CDN edge cache that fielded playback request as well as CDN efficiency data (e.g., did edge cache have to reach out to shield cache or origin of content) or a combination thereof. One or more of these same types of content distribution data may be collected and input into the machine learning model (e.g., after the model is trained) to process requests from users to determine whether the requested content should be fingerprinted. The training data may simulate and/or represent CDN traffic to train the machine learning model to identify certain types of data. The training data may train the machine learning model to identify media that one or more of: 1) is classified as high value by the business in the analysis service 210 from FIG. 2A (e.g., premiers of highly anticipated series, popular live sport matches, etc.), 2) surpasses an aggregate consumption threshold over a defined period, 3) has a high popularity for a specific geographic region, 4) has been previously been found pirated in the wild, 5) is from an IP address that is known to be associated with a VPN service or has requested all fragments of each ABR variant (e.g., atypical playback behavior), or any combination thereof. The machine learning model may be trained to flag any playback request with these features or combination of features to the fingerprint processor for watermarking.

The training data may be used simulate CDN traffic against a test suite of defined business rules that meet legal conditions for content distribution. The machine learning model may be trained to implement these business rules. The business rules may be implemented separately from the machine learning model. For example, the business rules may be implemented as a threshold to filter out requests (e.g., before inputting them into the machine learning model, or to further filter flagged results from the machine learning model). The business rules may be defined in a database and may contain the following information: Material ID, Content owner, aggregate playback threshold before mandatory watermarking, geographic location with mandatory watermarking, geographic location playback threshold before mandatory watermarking, denied geographic locations for playback as well as counters for each time these rules are queried (for upstream analytics). If any of these conditions are satisfied for a request for content, a request may be sent (e.g., based on a decision of the machine learning model and/or application of the business rules) to the fingerprint processor.

For example, a user, via a user device (e.g., user device 106), may request access to content. The content may be classified as high value (e.g., content has a high potential of being accessed via fraudulent means) by an analysis device 107 (e.g., analysis service 210). The content may be determined to be of high value due to the dataset at which the machine learning model may be trained on. The machine learning model may output a numerical value indicating the potential fraud risk. The risk of fraud may be determined based on a predetermined threshold indicating whether the content is at risk of fraud. If the numerical value is above the predetermined threshold the content may be determined at risk of fraud (e.g., and the fingerprinting process may be used to fingerprint the requested content). If the numerical value is below the predetermined threshold the content is not at risk of fraud (e.g., and the content may be provided without fingerprinting the content). As a result of determining the risk of fraud the machine learning model may determine that the content may need to be fingerprinted (e.g., applying (e.g., adding) watermark data to a subset of frames of a plurality of frames of content) prior to providing the content to the user (e.g., device 106).

The services device 108 may be configured to determine a subset of frames of the plurality of frames. The subset of frames of the plurality of frames may be determined based on the request. The subset of the plurality of frames may be determined based on the subset of the plurality of frames not being associated with one or more of a plurality of user accounts. The subset of frames of the plurality of frames may be unique to a user account among a plurality of user accounts accessing the content. The subset of frames may be different for two different watermarked copies of the content associated with two different corresponding user accounts. Services device 108 may be configured to determine whether the subset of the plurality of frames may be associated with one or more additional user accounts. Services device 108 may be configured to cause storage of an association of the user account and an indication of the subset of the plurality. The services device 108 may be configured to cause storage of the association of the user account and an indication of the subset of the plurality at storage device 105.

The services device 108 may be configured to add watermark data to each of the frames of the subset of frames of the plurality of frames. The addition of watermark data to each of the frames of the subset of frames of the plurality of frames may comprise generating a watermarked copy of the content. Adding the watermark data to each of the frames of the subset of the plurality of frames may comprise decoding the content, adding the watermark data to the subset of the plurality of frames of the decoded content, and encoding the content comprising the watermark data. The subset of the plurality of frames may comprise watermark data that may identify the user account. The watermark data may be user-generic. The watermark data may be the same for two different watermarked copies of the content associated with two different corresponding user accounts. For example, the same watermark data may be stored in different locations (e.g., frame locations, bit locations), for different user accounts. The watermark data may be user-specific. The watermark data may be different for two different watermarked copies of the content associated with two different corresponding user accounts. The watermark data may be the same in each of the frames of the subset of frames. The watermark data may be different for different frames in at least a portion of the subset of frames.

It should be noted that, even though frames are used through the present disclosure, the content may be subdivided in other ways than frames. For example, bit locations, segments, stream time locations, and/or the like may be used to identify a plurality of locations in the content. The services device 108 may determine a subset of the plurality of locations to insert watermark data. The subset of the plurality of locations may be associated with and/or identify a specific user account. It should also be noted that the subset of locations may vary for a particular user from one content item to another, from one portion of a content item to another, from one content network to another, from one time period to another, and/or the like.

The services device 108 may be configured to send the content comprising the watermark data. The content comprising the watermark data may be sent to the user device 106. The user device 106 may cause playback of the content. The user device 106 may be unaware of the watermark data. For example, the user device 106 may cause playback without checking for the watermark data. In some scenarios, the user device 106 may be configured to verify whether the content comprises the watermark data. For example, the user device 106 may perform any of the functions of the analysis device 107 described further herein. If the user device 106 is unable to verify the presence of the watermark data, then the user device 106 may stop playback and/or provide a notification to the user, the services device 108, the analysis device 107, the content device 102, and/or the like.

The analysis device 107 may be configured to analyze content, such as content associated with one or more user accounts. The analysis device 107 may comprise and/or implement a threat detection dashboard. The threat detection dashboard may be configured to identify various threats, such as unauthorized copying and/or access to content. The threat detection dashboard may be configured to implement a user interface, cause events to be triggered, and/or send notifications indicating potential threats.

The analysis device 107 may be configured to analyze flagged content (e.g., or any other content), such as content that is suspected to be downloaded to a device that does not have authorization to view the content. The service device 108 and/or user device 106 may send a watermarked copy of the content to the analysis device 107. The analysis device 107 may be configured to determine the subset of frames of the plurality of frames of the watermarked copy of the content. The analysis device 107 may be configured to determine a user account associated with the watermarked copy of the content based on the determined subset of frames of the plurality of frames. A user account may be associated with a particular subset of frames of the plurality of frames of the watermarked copy of the content, as the subset of frames of the plurality of frames may be unique to the user account among a plurality of user accounts accessing the content. Analysis device 107 may query the storage device 105 to determine the user account associated with the determined subset of frames of the watermarked copy of the content. The storage device 105 may comprise associations of user accounts with indications of corresponding subset of frames of the plurality of frames.

Analysis device 107 may be configured to send an indication of a user account, based on the subset of frames associated with the user account. The indication of the user account may be sent to one or more of a computing device (e.g., user device 106) or a storage device 105. The computing device that received the indication of the user account may be configured to output, based on the user account, an indication that the watermarked copy of content is associated with authorized or unauthorized access. For example, if the subset of frames of watermarked copy of the content received does not match the user account accessing the content, the indication may be associated with unauthorized access to the content. In some scenarios, the sending the indication of the user account may further comprise sending, by the computing device, the indication of the user account to a digital rights management process of a content player of the computing device. It is contemplated that the actions of analysis device 107 as described in the forgoing paragraphs may be performed by a user device 106, content device 102, services device 108.

It is contemplated that system 100 may be configured to perform the functions of the forgoing paragraphs for a plurality of devices accessing content. For example, services device 108 may be configured to determine a plurality of subsets of frames of a plurality of frames of content. The plurality of subsets of frames of a plurality of frames of content may be determined based on a plurality of requests associated with corresponding user accounts of a plurality of accounts. Services device 108 may be configured to add watermark data to the plurality of subsets of frames of the plurality of frames of content. The watermark data may be added based on the plurality of requests. The plurality of subsets of frames may be watermarked based on a decision by a machine learning model. The machine learning model may be configured to one or more of: indicate a risk level associated with the content or indicate whether to watermark the content or not. Services device 108 may be configured to send the plurality of copies of content. Each copy of content may be sent to the user account associated with the request. Services device 108 may cause storage of a plurality of associations of user accounts with corresponding indications of the subset of the plurality. For example, the association of each user account with the corresponding indication of a subset of frames may be stored via a storage device 105. Each respective subset of frames associated with a user account of the plurality of user accounts may be unique to each user account accessing the content. Further, analysis device 107 may be configured to determine for at least one of the plurality of subsets of frames, whether the subset of the plurality of frames may be already associated with one or more of the plurality of user accounts. It should be noted the process performed by the services device 108 may be performed by any of the devices of FIG. 1, such as the content device 102, the user device 106, the network device 104, the storage device 105, the analysis device 107, or a combination thereof.

FIG. 2A shows a block diagram of an example system 200. The system 200 may comprise devices and features as described in FIG. 1, such as but not limited to a content service 215, a network 110, a services device 108, user device 106, an analysis service 210, or a combination thereof. The system 200 may comprise a service provider network 220, a network 209 (e.g., the network 110 of FIG. 1), one or more user devices 217 (e.g., user device 106), or any combination thereof. The service provider network 220 may be associated with a fingerprinting service 206, an analysis service 210, a content service 215, or any combination thereof. Service provider network 220 may comprise one or more of the devices and features as described in FIG. 1. Service provider network 220 may comprise a number of processors, a number of databases, a number of machine learning models, or any combination thereof.

Service provider network 220 may comprise a computing device, a gateway device, a termination system, an access point (e.g., wireless access point), a router, a modem, a device controller (e.g., automation controller, security controller, fraud controller, content device controller), a switch, a network node, or the like, or any combination thereof. Service provider network 220 may comprise a number of devices associated with one or more of a number of machine learning models, a number of databases, a number of processors, or any combination thereof. Service provider network 220 may be configured to facilitate communications between devices and services of system 200. Service provider network 220 may be configured to communicate with one or more user devices 207 (e.g., which may include any of the features of the user device 106 of FIG. 1) using a network 209.

The system 200 may comprise a fingerprinting service 206. The fingerprinting service 206 may be performed by one or more of the devices and/or features as described in FIG.1. Fingerprinting service 206 may comprise a number of processors, a number of databases, a number of machine learning models, or any combination thereof. Fingerprinting service 206 may comprise a Mezzanine (e.g., Mezz) content storage 201, a fingerprint processor 202, a fingerprint database 203, a fingerprinting machine learning model 204, a remote file access (e.g., RFA) content storage 205, or any combination thereof. The RFA content storage 205 may comprise a ‘Ready For Air’ storage location from which the content origin 216 may retrieve fingerprinted assets. The RFA content storage 205 may be configured to store content comprising watermarked copies of content (e.g., fingerprinted assets) associated with a user account. Mezz content storage 201 may be configured to store content. The content may comprise a plurality of frames. The content stored in the Mezz content storage 201 may comprise content that is not watermarked. The Mezz content storage 201 may be configured to transmit (e.g., send) unwatermarked content to fingerprint processor 202 as based on a request to access content. The fingerprint processor 202 may be configured to watermark a subset of frames of a plurality of frames associated with content. Fingerprint processor 202 may apply watermarking (e.g., watermarking to a unique subset of frames) associated with a user account. Fingerprint processor 202 may generate a watermarked copy of content. Fingerprint processor 202 may generate a unique identifier for each of the frames of the subset of frames and/or a unique identifier for the subset of frames. An indication of the unique subset of frames and/or the association thereof with a user (e.g., or user account) may be stored in a fingerprint database 203.

The fingerprint database 203 may be configured to store a unique identifier associated with the subset of frames, an indication of the specific frames of the subset, and/or fingerprinting session data (e.g., metadata) associated with the fingerprinting service 206. The fingerprint database 203 may be configured to store the location (e.g., bit locations of segments, frame locations, content stream time locations) of the subset of frames of the plurality of frames of content and a user account associated with that subset of frames of the plurality of frames. The user account may be determined using a number of datapoints associated with a user device, such as but not limited to, IP address, a login to a platform associated with fingerprinting service 206, device type, or any other suitable datapoint. Fingerprint processor 202 may transmit the watermarked copy of content to RFA content storage 205. The transmitted watermarked copy of content may comprise a plurality of frames of content comprising the watermarked subset of frames, and audio associated with the content. RFA content storage 205 may store a number of watermarked copies of content, such that if a request for content is received, RFA content storage 205 may send the corresponding watermarked copy of content associated with the request to a user device 207.

The Fingerprinting machine learning model 204 may be trained to determine whether to watermark content. The fingerprinting machine learning model 204 may be trained to determine whether to watermark the content based on one or more of: metadata associated with the content, content popularity, content usage patterns, unauthorized access patterns, a set of rules defined by fingerprinting service 206, and/or any combination thereof. The set of rules may be associated with a particular user, association, organization, or the like. The fingerprinting machine learning model 204 may determine content popularity by any suitable means, such as but not limited to, a number of times content has been mentioned in media (e.g., newspapers, tv shows, news outlets, or the like), a number of times users may have requested the content, or the like, or any combination thereof. The fingerprinting machine learning model 204may be trained to perform media info processing on a source asset (e.g., count total number of frames in asset) (e.g., fingerprinting machine learning model 204 may be trained to determine a number of frames associated with the content requested). For example, the fingerprinting machine learning model 204 (e.g., or the fingerprinting servicer 206) may determine the number of plurality of frames of content. The fingerprinting machine learning model 204 (e.g., or the fingerprinting servicer 206) may be configured to determine random frames (e.g., subset of frames of the plurality of frames) of the number of frames determined. The subset of frames of the plurality of frames may be user specific. The results of fingerprinting machine learning model 204 may be transmitted and received by the fingerprint processor 202. It is contemplated that in some examples, fingerprinting machine learning model 204 may comprise one or more machine learning models trained to perform one or more of the functions, processes, or operations of fingerprinting machine learning model 204.

The analysis service 210 may comprise a number of processors, a number of databases, a number of machine learning models, or any combination thereof. Analysis service 210 may comprise a fraud detection machine learning model 211 associated with fraud discovery, a Fingerprint and Consumer Device database, and a dashboard/alert system 213 that may be implemented by one or more servers associated with analysis service 210. The fraud detection machine learning model 211 may be configured to assess (e.g., evaluate) content data associated with a content service 215. Content data may be assessed such that popular content may be determined via fraud detection machine learning model 211. Fraud detection machine learning model 211 may be configured to evaluate content delivery network (e.g., CDN) consumption data to determine popularity associated with a content item. Fraud detection machine learning model 211 may be configured to determine a potential popularity associated with the content based on a number of requests received in a particular time period. The particular time period may be determined (e.g., set) by the analysis service 210 and/or an organization associated with analysis service 210. Fraud detection machine learning model 211 may analyze content data, CDN, or any combination thereof in relation to a set of business rules. The set of business rules may be determined by one of an entity, an organization, or a user, associated with analysis service 210 via a dashboard/alert system 213. Fraud detection machine learning model 211 may be communicatively connected to fingerprint database 203. Fraud detection machine learning model 211 may reference fingerprint database 203 to receive the association between a subset of a plurality of frames of content and a user account. Fraud detection machine learning model 211 may access fingerprint database 203 to monitor the association of a user account and a subset of plurality of frames of content for determined popular content. Fraud detection machine learning model 211 may reference fingerprint database 203 as content service 215 may send a watermarked copy of content to a user device. Fraud detection machine learning model 211 may be configured to compare the user account associated with content data (e.g., received content via content service 215 or associate with content playback on a user device 106) to the association of the subset of frames of the plurality of frames of content and the user account associated with the subset of frames to determine whether fraud has occurred. Fraud (e.g., or unauthorized access) may have occurred if the user account accessing the content does not match the association of the subset of frames associated with another user account of a number of user accounts. Fraud detection machine learning model 211 may be configured to generate a fraud report if fraud is determined. The fraud report may be provided via a dashboard/alert system 213 to an organization, security organization, police force or the like.

Fraud detection machine learning model 211 may be configured to analyze various attributes of and patterns associated with a user and content. The fraud detection machine learning model 211 may be trained on a fraud training dataset. The fraud training dataset may comprise datapoints associated with legitimate (e.g., a user with access services device 108 or content being request) and datapoints associated with fraudulent activity. Fraudulent activity may include but not limited to scenarios in which a user is known to not have access to services device 108 and is accessing and/or requesting content associated with services device 108, a user is accessing a watermarked copy of content associated with another user, or the like, or any combination thereof. The fraud training dataset may comprise both legitimate and fraudulent activity such that the machine learning model may learn to distinguish features and characteristics of both legitimate and fraudulent activity associated with content. Fraud detection machine learning model 211 may analyze new, unseen content, requests for the content, and data associated with the request to the content. The fraud detection machine learning model 211 may assign, based on the analysis, a fraud score based on the likelihood of the content being fraudulent (e.g., the user does not match the watermarked copy of content associated with another user of a plurality of users). The fraud score may be calculated by examining factors such as content metadata, user behavior, historical patterns, a location associated with the watermark data on a subset of frames. If the fraud score exceeds a predetermined fraud threshold, the fraud detection machine learning model 211 may flag (e.g., determine) that the content is being accessed fraudulently. The machine learning model may present the fraudulent activity to a user (e.g., user device 106) of the dashboard/alert system 213 such that the user may take appropriate actions (e.g., confirm, review, report, or the like, or any combination thereof) on the fraudulent activity.

The fraud detection machine learning model 211 may be configured to match previously watermarked content with our database. The detection machine learning model 211 may be configured to provide a binary yes/no classification. To train the fraud detection machine learning model 211, test content associated with defined web locations may be used. Once trained the fraud detection machine learning model 211 may be put in production mode.

In production mode, the fraud detection machine learning model 211 (e.g., and/or related processes that input data into the fraud detection machine learning model 211) may be configured to search a plurality of network locations (e.g., crawl the web) looking for content matching our unique watermarked patterns. The fraud detection machine learning model 211 may perform a HTTP GET on discovered content (e.g., web media content). The fraud detection machine learning model 211 may decode discovered content to identify the pattern (e.g., which subset of frames of the frames of the content have the watermark data) of watermarked frames. The fraud detection machine learning model 211 may look up the discovered pattern against a database (e.g., fingerprints and consumer device database 212) of uniquely watermarked content and determine if there is a match. If a match is discovered, a notification may be sent for takedown of the content. The notification may include any of the following data: a unix epoch timestamp, a material ID of content, a content owner, an IP address that served pirated content, an IP business owner name, an IP geographical location, still images of each watermarked frame as well as watermarked frame pattern (e.g., in [00010000001…..0000100000] format where 0 = non-watermarked frame and 1 = watermarked frame) so an operator can independently validate findings.

Analysis service 210 may host or provide a dashboard/alert system 213 to an organization or individuals interested in fraud detection. The dashboard/alert system 213 may be configured for facilitating communications among entities or provisioning content among entities. Dashboard/alert system 213 may be implemented by a server of analysis service 210. It is contemplated that dashboard/alert system 213 may be located on or interact with one or more devices (e.g., user device 207) associated with the system 200. Dashboard/alert system 213 may be a network-addressable computing system that can host an online fraud detection network. Dashboard/alert system 213 may receive, generate, store, or send watermark data. dashboard/alert system 213 may utilize the fraud detection machine learning model 211 to determine whether fraud has occurred associated with a user account and content accessed. Dashboard/alert system 213 may be assessed by one or more components of the system 200 directly or via network 250. As an example, and not by way of limitation, a device (e.g., user device 106) may access dashboard/alert system 213 by a web browser or a native application on a device associated with analysis service 210 (e.g., a mobile fraud detection application, a mobile services application, a mobile policing application, another suitable application, or any combination thereof) directly or via network 250. Dashboard/alert system 213 and fraud detection machine learning model 211 may reference a Fingerprint and Consumer Device database 212 associated with the analysis service 210 to aid in the determination of whether fraud has been committed by a user.

The Fingerprint and Consumer Device database 212 may store a location associated with a subset of frames of the plurality of frames of copied watermarked content received via the content service 215 or a user device 207. Fingerprint and Consumer Device database 212 may store the location of the subset of frames associated with playback streams of the watermarked copy of content. Fingerprint and Consumer Device database 212 may store user device information (e.g., non-personal identifiable information) associated with playback streams of a watermarked copy of content. Fingerprint and Consumer Device database 212 may store network data associated to a network connectivity associated with the user device 207 that has accessed the watermarked copy of content.

The content service 215 may comprise a number of processors, a number of databases, a number of machine learning models, or any combination thereof. Content service 215 may be located on a premises associated with a user, associated with a network. Content service 215 may comprise a content origin/shield cache 216. Content service 215 may provide the user (e.g., one or more user devices 207) the content item associated with the request. Content services 215 may be configured to receive a request for content, via a user (e.g., content services 215 may be associated with a user interface associated with a user device (e.g., user device 207) that may allow for a user to request content). If the fingerprinting machine learning model 204 has flagged the asset for fingerprinting (e.g., based on receiving a request of content, the fingerprinting model 204 may determine if the content may be watermarked) the content may be watermarked using the methods described herein, such as by adding watermark data to a subset of frames associated with the requesting user device. Content services 215, may issue a hypertext transfer protocol (HTTP) 302 (e.g., redirect) to the ‘new’ watermarked asset for the end-user in RFA content storage 205 (e.g., content services 215 may redirect the user device 207 to the watermarked copy of content stored via RFA content storage 205). Content services 215, may be configured to transmit a watermarked copy of content to a user device (e.g., user device 106) associated with the user.

The one or more user devices 207 as illustrated in FIG. 2A may be an illustration of the many examples of a user device 106 as discussed with FIG. 1. The one or more user devices 207 of FIG. 2A may (e.g., may each) may comprise an electronic device including hardware, software, embedded logic components, or a combination of two or more such components and capable of carrying out the appropriate functionalities implemented or supported by the user device 207. As an example and not by way of limitation, the one or more user devices 207 may be each be computing device, such as a smart device (e.g., smart glasses, smart watch, smart phone), a desktop computer, a notebook or laptop computer, netbook, tablet, handheld electronic device, mobile device, a computing station, a laptop, a digital streaming device, a set-top box, a streaming stick, a television, other suitable electronic device, or any suitable combination thereof. In some scenarios, a user may have multiple user devices, such as a mobile phone, a smart watch, smart glasses, a combination thereof, and/or the like. The one or more user devices 106 may enable a user (e.g., or multiple users) to access a network (e.g., network 209). The one or more user devices 106 may be configured to enable user(s) to communicate with content services 215 or other users at another device associated with one or more networks (e.g., network 209), such as other user devices (e.g., user devices 106).

FIG. 2B illustrates an example process flow 250 associated with the fingerprint processor 202. The process flow 250 may begin at 251, the fingerprint processor may determine if a request to fingerprint is received. The fingerprinting machine learning model 204 may send a request to fingerprint to fingerprint processor 202 if the fingerprinting machine learning model 204 determines the content needs fingerprinting. At 252, a process for fingerprinting (e.g., or watermarking) the content may start. At 253, the fingerprinting processor 202 may validate the content being requested. At 254, the fingerprint professor 202 may determine if the content is available. If the content is not available, the process may proceed to 255. At 255, the fingerprint processor 202 may notify (e.g., send an HTTP 404) a user via a user device (e.g., user device 106) that the content is not available. At 256, the process flow 250 associated with fingerprint processor 202 may end (e.g., terminated), as such no content may be presented (e.g., shown) to the user associated with the request.

At 254, if the fingerprinting processor 202 determined that the content is available, the process flow 250 may continue to 257. At 257, the fingerprinting processor 202 may generate a list of frames (e.g., randomly select a subset of frames of the plurality of frames associated with content). At 258, the frame list may be associated with a user account, the user account may be associated with one or more devices (e.g., user device 106). At 259, the fingerprinting processor 202 may retrieve non-fingerprinted assets (e.g., content item without watermarked frames) from a Mezz content storage 201. At 260, fingerprinting processor 202 may apply fingerprint (e.g., watermarking) to the content retrieved from the Mezz content storage 201. The content retrieved from Mezz content storage may be audio and/or a plurality of video frames associated with the content. The fingerprinting processor 202 may apply a fingerprint (e.g., watermark) to a subset of frames of the plurality of frames of content, generated at 259. At 261, fingerprinting processor 202 may package the watermarked subset of frames of the plurality of frames of content with the audio and/or plurality of frames associated with content retrieved from Mezz content storage 201. The packaged watermarked subset of frames of the plurality of frames and audio and/or plurality of frames associated with content may create (e.g., constitute) a watermarked copy of content. The watermarked copy of content may comprise a watermarked subset of frames of the plurality of frames of content. At 262, the packaged content (e.g., watermarked copy of content) may be stored in a RFA content storage 205. RFA content storage 205 may be communicatively connected to content services 215 such that the watermarked copy of content may be presented (e.g., transmitted) to a user via a user device (e.g., user device 106). At 263, metadata associated with the fingerprinting session may be stored. The fingerprinting processor 202 may store a location of the randomly generated frames at 259, the location of the randomly generated frames may be stored with other suitable data associated with a fingerprinting session (e.g., a location associated with the subset of frames of the plurality of frames of content may be stored in conjunction with an IP address, device type, time content was requested, or the like, or any other suitable non-PII data). The fingerprint database 203 may be configured to pair metadata associated with a fingerprinting session and the location associated with the subset of frames with a particular user, user account, user device, or any combination thereof.

FIG. 2C shows a number of watermarked copies of content associated with one or more user accounts (e.g., clients). The watermarked copies illustrated may be associated with a request. In the example shown, one or more users associated with a user device (e.g., device 276a, 276b, 276c, 276d, 276e) may have requested the same content. The user devices (e.g., e.g., device 276a, 276b, 276c, 276d, 276e) may be similar to the user device 106 of FIG. 1. The network 110 may be the network as disclosed with the description of FIG. 1. One or more users may have sent a request to a content service (e.g., content service 215). The request may be associated with content. The request may be the same for each of the one or more users (e.g., device 276a, 276b, 276c, 276d, 276e). Utilizing the methods and/or processes of FIGS. 1, 2A, and/or FIG. 2B a watermarked copy of content (e.g., watermarked copy of content 280a, 280b, 280c, 280d, 280e) may be generated and sent to each of the one or more users (e.g., device 276a, 276b, 276c, 276d, 276e), respectively. The watermarked copy of content may comprise a subset of frames of the plurality of frames of content. The subset of frames of the plurality of frames of content may comprise watermark data. The location of the subset of frames of the plurality of frames of content may be different for each of the one or more users (e.g., e.g., device 276a, 276b, 276c, 276d, 276e) as shown in the FIG. 2C. A packager, such as a just in time packager, may be configured to package the watermarked content into a corresponding format associated with the requesting user device. Though multiple packagers are shown, as few as a single packager may be used for each of the requests.

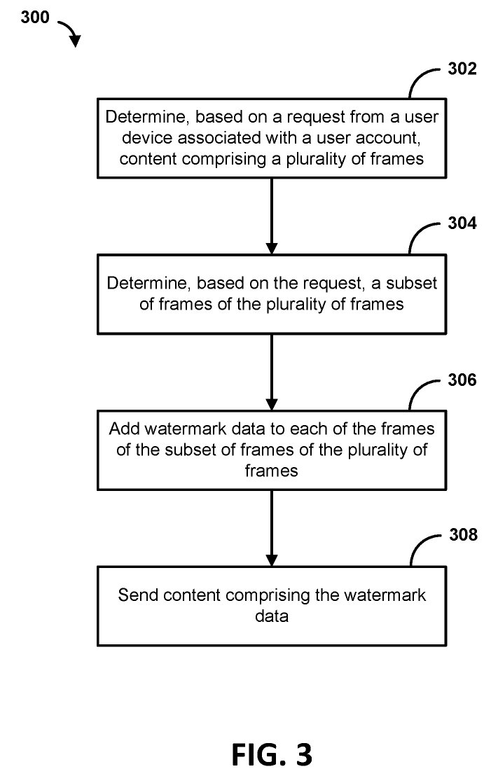

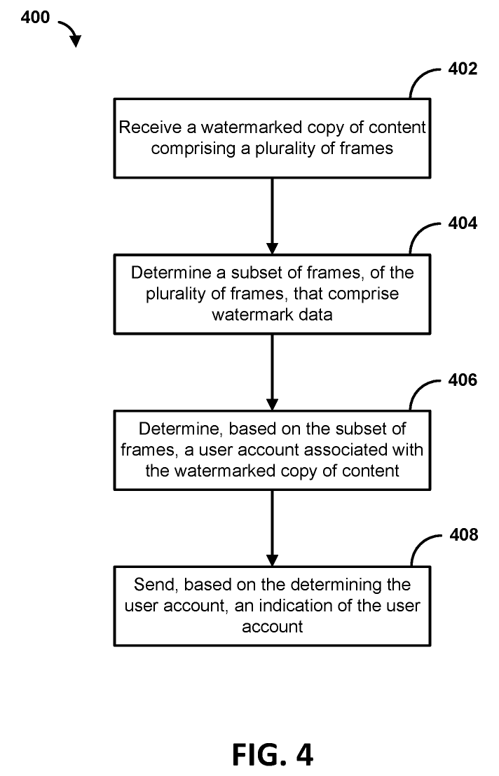

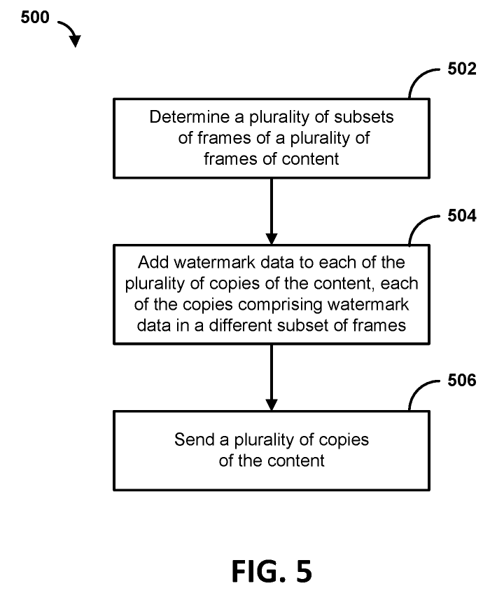

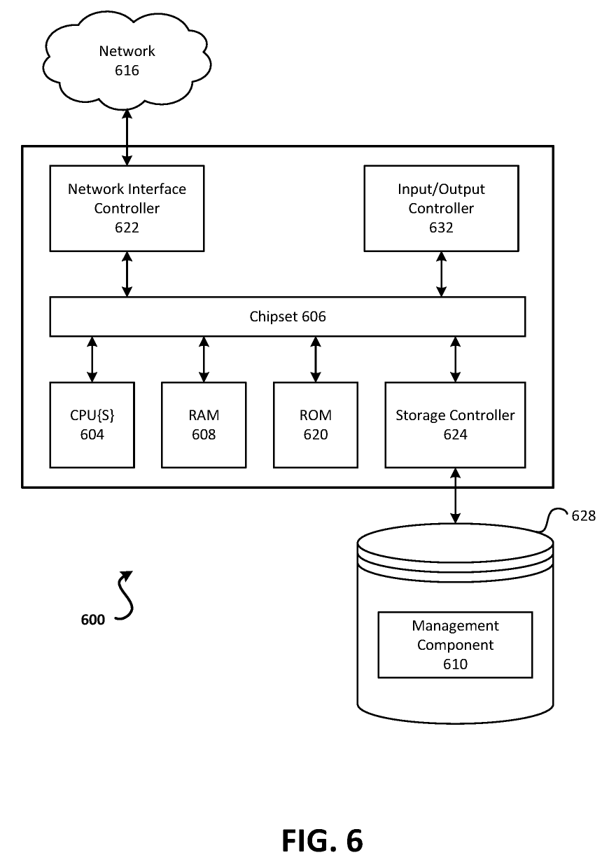

FIG. 3 shows an example method. The method 300 may comprise a computer implemented method for providing a service (e.g., a content service, a network service, a communication service, or a combination thereof). A system and/or computing environment, such as the system 100 of FIG. 1, FIGS. 2A-C, and/or the computing environment of FIG. 6, may be configured to perform the method 300. The method 300 may be performed in connection with the system illustrated in FIG. 1 or the systems illustrated in FIG. 2. Any step or combination of steps of the method 300 may be performed by a computing device, network device, network node, and/or client device, such as any of the devices shown in FIG. 1 or FIGS. 2A-C. Any of the features of the methods of FIGS. 4 and FIG. 5 may be combined with any of the features and/or steps of the method 300 of FIG. 3.

At step 302, content comprising a plurality of frames may be determined. The content may be determined based on a request from a user device associated with a user account. The content may comprise video, audio, or a combination thereof. The content may comprise one or more segments of content comprising the plurality of frames. The user device may be configured to send the request to a computing device, network device, network node, and/or client device, such as any of the devices of illustrated in FIG. 1, to receive content comprising a plurality of frames.

A user, associated with a user account may utilize a device (e.g., user device 106) to request to watch a movie associated with a server device (e.g., services device 108). The server device may communicate with a content device (e.g., content device 102), via a network (e.g., network 110), to receive a plurality of frames associated with the movie. The plurality of frames may be determined based on the request from the user to access content (e.g., the movie) via a server device (e.g., services device 108).

At step 304, a subset of frames of the plurality of frames may be determined. The subset of frames may be determined based on the request. The subset of frames of the plurality of frames may be unique to the user account among a plurality of user accounts accessing the content. As such, a determination of the subset of frames of the plurality of frames being associated with one or more additional user accounts may be determined such that no two user accounts are associated with the same subset of frames. The subset of frames may be different for two different watermarked copies of the content associated with two different corresponding user accounts. An association of the user account and an indication of the subset of the plurality of frames may be caused to be stored in a data store (e.g., storage device 105).

A first user account (e.g., a first user) and a second user account (e.g., a second user) associated with a first device (e.g., user device 106) and a second device, respectively, may send a request to a server device (e.g., services device 108) to watch a movie. The server device may communicate with a content device (e.g., content device 102) to determine a plurality of frames associated with the movie. Server device may the receive the content comprising a plurality of frames. Server device may determine a subset of frames (e.g., or other subset of locations) of the plurality of frames based on the request to access the movie (e.g., content) associated with each user account. The subset of frames of the plurality of frames associated with the movie may be unique to the first user and unique to the second user. The association between the subset of frames determined for the first user may be stored for the first user and the subset of frames determined for the second user may be stored for the second user.

At step 306, watermark data may be added to each of the frames of the subset of frames of the plurality of frames associated with content. A machine learning model may be utilized to determine whether to watermark the content. The machine learning model may be configured to indicate one or more of: a risk level associated with the content or whether to watermark the content or not. The watermark data may be generated as a response to the request to access content. The watermark data added to the subset of the plurality of frames may be used to identify a user account of a plurality of user accounts. Adding watermark data to each of the frames of the subset of the plurality of frames may be based on the subset of frames not being associated with one or more additional user accounts. The addition of watermark data to each of the frames of the subset of frames of the content may comprise generating a watermarked copy of the content. The watermark data may be user-generic. The watermark data may be the same in each of the frames of the subset of frames. The watermark data may be unique to a user account of a plurality of user accounts. The watermark data may be unique for different frames in at least a portion of the subset of frames. The watermark data may be the same for a plurality of user accounts, however the subset of frames of the plurality of frames may be unique to each user account. The watermark data may be different for each copy of watermarked content to a plurality of user accounts. Watermarking each of the frames of the subset of frames of the plurality of frames may comprise decoding the content, adding the watermark data to the subset of the plurality of frames of the decoded content, and/or encoding the content comprising the watermark data associated with the subset of frames.

A first user, based on a request to access a movie may initiate the determination of a plurality of frames associated with the movie. A first subset of frames may be determined from the plurality of frames of the movie (e.g., content). Based on an indication to watermark the movie, watermark data may be added to each of the frames of the first subset of frames. The first subset of frames may be unique to the first user. The movie with watermark data on each of the determined first subset of frames may be a first watermarked copy of the movie. Conversely, a second user, based on a request to access the movie, may initiate the determination of a plurality of frames associated with the movie. A second subset of frames may be determined from the plurality of frames of the movie (e.g., content). Based on an indication to watermark the movie, watermark data may be added to each of the frames of the second subset of frames. The second subset of frames may be unique to the second user. The movie with watermark data on each of the determined second subset of frames may be a second watermarked copy of the movie. The first user and the second user may be identified by the subset of frames associated with the watermarked copy of content. For example, for the first user, a first subset of frames may be mapped (e.g., uniquely associated with in a datastore) to a user account of the first user (e.g., in a database). The mapping may be an association of a user account identifier with data (e.g., a vector, a list, array, identifier of the subset) that one or more of indicates or identifies the subset of frames. For example, if the subset included frames 2, 5, 8, and 10, then the mapping may comprise a data structure that indicates frames 2, 5, 8, and 10 (e.g., or an identifier to another entry in the data structure than includes the frames 2, 5, 8, and 10). The mapping may identify the content, such as by associating a content identifier with the account identifier and/or identifier of the subset of frames. In some scenarios, the mapping may identifier a particular segment of the content. Similarly, the second subset of frames may be mapped to a user account of the second user, such as through another entry in the same database storing the mapping for the first user.

At step 308, the content comprising the watermark data associated with a subset of frames of a plurality of frames may be sent to a computing device (e.g., user device 106). It is contemplated that the content comprising watermark data may also be sent to the content device 102, storage device 105, network device 104, or any other suitable device. The content comprising watermark data may only have watermark data on a subset of frames of a plurality of frames of the content. The positioning of the watermark data in regard to the subset of frames may be unique to a user account of a plurality of user accounts.

FIG. 4 shows an example method. The method 400 may comprise a computer implemented method for providing a service (e.g., a content service, a network service, a communication service, or a combination thereof). A system and/or computing environment, such as the system 100 of FIG. 1, FIGS. 2A-C, and/or the computing environment of FIG.6, may be configured to perform the method 400. The method 400 may be performed in connection with the system illustrated in FIG. 1 or the systems illustrated in FIGS. 2A-C. Any step or combination of steps of the method 400 may be performed by a computing device, network device, network node, and/or client device, such as any of the devices shown in FIG. 1 and/or FIGS. 2A-C. Any of the features of the methods of FIG. 3 and FIG. 5 may be combined with any of the features and/or steps of the method 400 of FIG. 4.

At step 402, a watermarked copy of content may be received. The watermarked copy of content may comprise a plurality of frames may be received. The watermarked copy may be a copy of content comprising watermark data on each of the frames of a subset of frames of the plurality of frames associated with the content. The subset of frames of the plurality of frames associated with the content may be watermarked based on whether a machine learning model indicates one or more of: a risk level associated with the content or whether to watermark the content or not.

At step 404, a subset of frames that comprises watermark data may be determined. The subset of frames that comprises watermark data may be determined of and/or from the plurality of frames. The watermark data may be user-generic. For example, the same watermark data may be used for multiple users (e.g., though the location/frames in which the watermarked data is stored in the content may be different). The watermark data may be the same in each of the frames of the subset of frames (e.g., the same bit sequence, token, or other data may be added to different frames). The watermark data may be user-specific. For example, each user may have different watermark data, or at least partially different watermark data from other users. The watermark data may be different for different frames in at least a portion of the subset of frames. The watermark data may be the same for two different watermarked copies of the content associated with two different corresponding user accounts of a plurality of user accounts. The watermark data may be different for two different watermarked copies of the content associated with two different corresponding user accounts. The subset of frames may be different for two different watermarked copies of the content associated with two different corresponding user accounts of a plurality of user accounts. Determining the subset of frames may comprise searching at least a portion of the content for the watermark data and updating the subset to include indications of frames comprising the watermark data.

At step 406, a user account associated with the watermarked copy of the content may be determined. The user account associated with the watermarked copy of the content may be determined based on the subset of frames. Determining the user account may comprise querying a datastore of watermarking information. The data store may comprise associations of user accounts with indications of the corresponding subset of frames of the plurality of frames. where the subset of frames of the plurality of frames may be unique to the user account among a plurality of user accounts accessing the content.

At step 408, an indication of the user account may be sent. The indication of the user account may be sent based on the determination of a user account associated with the watermarked copy of content. Sending the indication of the user account may comprise sending the indication of the user account to one or more of a computing device or a storage device. Sending the indication of the user account may comprise sending, by a computing device or a storage device, the indication to a digital rights management process of a content player of the computing device. Based on the indication of a user account, the computing device or the storage device may be configured to output an indication that the watermarked copy of the content is associated with authorized or unauthorized access.

FIG. 5 shows an example method. The method 500 may comprise a computer implemented method for providing a service (e.g., a network service, a communication service). A system and/or computing environment, such as the system 100 of FIG. 1, FIGS. 2A-C, and/or the computing environment of FIG. 6, may be configured to perform the method 500. The method 500 may be performed in connection with the system illustrated in FIG. 1 and FIGS. 2A-C. Any step or combination of steps of the method 500 may be performed by a computing device, network device, network node, and/or client device, such as any of the devices shown in FIG. 1 and/or FIGS. 2A-C. Any of the features of the methods of FIG. 3 and FIG. 4 may be combined with any of the features and/or steps of the method 500 of FIG. 5.

At step 502, a plurality of subsets of frames of a plurality of frames of content may be determined. The plurality of subsets of frames of a plurality of frames of content may be determined based on a plurality of requests associated with corresponding user accounts of a plurality of user accounts. For example, each time a user account requests the content, a determination may be made of a specific subset of frames to be associated with that specific user account. An association of each subset of frames of the plurality of subsets of frames of the plurality of frames of content and the corresponding user account may be stored in a data store. The data store may be storage device 105 or any other suitable device of FIG. 1. The determined subset of frames of the plurality of frames of content may be determined based on whether the subset of frames of the plurality of frames may be already associated with one or more of the plurality of user accounts. The subsets of frames associated with a user account of a plurality of user accounts may be referenced to determine a subset of frames not associated with a user account.

At step 504, watermark data may be added to the plurality of subsets of frames of the plurality of frames of the copies of the content. A machine learning model (e.g., or other model or rule) may be utilized to determine whether to add watermark data to the copies of content. The machine learning model may be configured (e.g., trained) to one or more of: indicate a risk level associated with the content or indicate whether to watermark the content or not.

The watermark data may be added to the plurality of copies of the content based on a plurality of requests associated with a plurality of users accessing content. Each of the copies of content may comprise the watermark data in a different subset of frames, associated with a user account of a plurality of user accounts, of the plurality of subsets of frames. Watermarked data associated with the subsets of frames of the plurality of frames of the content may be used to identify a user account. The watermark data may be user-generic. The watermark data may be the same in each of the frames of the plurality of subset of frames for each of the plurality of copies of the content. The watermark data may be user-specific. The watermark data may be different for different frames in at least a portion of the subset of frames. The watermark data may be the same for a plurality of different copies of the content associated with the corresponding plurality of user accounts. The watermark data may be different for two different watermarked copies of the content associated with two different corresponding user accounts. Adding the watermark data to the plurality of copies of the content may be based on the subset of the plurality of frames not being already associated with one or more of the plurality of user accounts.

At step 506, the plurality of copies of the content may be sent based on the plurality of requests to access content. The each of the copies of the plurality of copies may be sent to a computing device associated with a request of the plurality of requests. The copy received may indicate a user account of a plurality of user accounts associated with the request. The copy may not directly indicate the user account by a particular and/or explicit identifier. Instead, the particular watermarking scheme (e.g., which subset of frames has the watermarking data) may be used by any device programmed to understand the watermarking scheme to identify the user account.

FIG. 6 depicts a computing device that may be used in various aspects, such as the servers, modules, and/or devices depicted in FIG. 1 and FIGS. 2A-C. With regard to the example architecture of FIG. 1, the content device 102, network device 104, storage device 105, the user device 106, the analysis device 107, and any devices of the network 110 may each be implemented in an instance of a computing device of FIG. 6. With regard to the example architecture of FIG. 2A-C, any devices of fingerprinting service 206, the analysis service 210, the content service 215, the user devices 207, and the packager may each be implemented in an instance of a computing device of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1, FIGS. 2A-C, FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 1, FIGS. 2A-C, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly the phrase “one or more of A, B, and C” includes any of the following: A, B, C, A and B, A and C, B and C, and A and B and C. The phrase “at least one of A, B, or C” includes any of following: A, B, C, A and B, A and C, B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
determining, based on a request from a user device associated with a user account, content comprising a plurality of frames;
determining, based on the request, a subset of frames of the plurality of frames;
adding watermark data to each of the frames of the subset of frames of the plurality of frames, wherein the subset of the plurality of frames comprising the watermark data identifies the user account; and
sending, to the user device, the content comprising the watermark data.

2. The method of claim 1, wherein the watermark data is the same in each of the frames of the subset of frames.

3. The method of claim 1, further comprising causing storage of an association of the user account and an indication of the subset of the plurality.

4. The method of claim 1, wherein the subset of frames of the plurality of frames is unique to the user account among a plurality of user accounts accessing the content.

5. The method of claim 1, further comprising determining whether the subset of the plurality of frames is associated with one or more additional user accounts, wherein adding the watermark data to each of the frames of the subset of the plurality of frames is based on the subset of frames of the plurality of frames not being associated with the one or more additional user accounts.

6. The method of claim 1, further comprising determining, based on a machine learning model, whether to watermark the content, wherein the machine learning model is configured to one or more of: indicate a risk level associated with the content or indicate whether to watermark the content or not.

7. The method of claim 1, wherein adding the watermark data to each of the frames of the subset of the plurality of frames comprises decoding the content, adding the watermark data to the subset of the plurality of frames of the decoded content, and encoding the content comprising the watermark data.

8. A method comprising:
receiving a watermarked copy of content comprising a plurality of frames;
determining a subset of frames, of the plurality of frames, that comprises watermark data;
determining, based on the subset of frames, a user account associated with the watermarked copy of the content; and
sending, based on the determining the user account, an indication of the user account.

9. The method of claim 8, wherein the watermark data is the same in each of the frames of the subset of frames.

10. The method of claim 8, wherein determining the user account comprising querying a datastore of watermarking information, wherein the datastore comprises associations of user accounts with indications of corresponding subset of frames of the plurality of frames.

11. The method of claim 8, wherein the subset of frames of the plurality of frames is unique to the user account among a plurality of user accounts accessing the content.

12. The method of claim 8, wherein the content is watermarked based on whether a machine learning model one or more of: indicates a risk level associated with the content or indicates to watermark the content.

13. The method of claim 8, wherein sending the indication of the user account comprises sending the indication to one or more of a computing device or a storage device, wherein the computing device is configured to output, based on the indication of the user account, an indication that the watermarked copy of the content is associated with authorized or unauthorized access.

14. The method of claim 8, wherein determining the subset of frames comprises searching at least a portion of the content for the watermark data and updating the subset to include indications of frames comprising the watermark data.

15. A method comprising:
determining, based on a plurality of requests associated with corresponding user accounts of a plurality of user accounts, a plurality of subsets of frames of a plurality of frames of content;
adding, based on the plurality of requests, watermark data to a plurality of copies of the content, wherein each of the copies of the content comprises the watermark data in a different subset of frames, associated with the corresponding user account, of the plurality of subsets of frames such that the subset of frames used identifies the user account; and
sending, based on the requests, the plurality of copies of the content.

16. The method of claim 15, wherein the watermark data is the same in each of the frames of the subset of frames for each of the plurality of copies of the content.

17. The method of claim 15, further comprising causing storage of a plurality of associations of user accounts with corresponding indications of the subset of the plurality.

18. The method of claim 15, wherein the respective subset of frames of the plurality of frames is unique to each user account among the plurality of user accounts accessing the content.

19. The method of claim 15, further comprising determining, for at least one of the plurality of subsets of frames, whether the subset of the plurality of frames is already associated with the one or more of the plurality of user accounts, wherein adding the watermark data to the plurality of copies of the content is based on the subset of the plurality of frames not being already associated with one or more of the plurality of user accounts.

20. The method of claim 15, further comprising determining, based on a machine learning model, whether to watermark the content, wherein the machine learning model is configured to one or more of: indicate a risk level associated with the content or indicate whether to watermark the content or not.
